(19) United States
(12) Patent Application Publication
(10) Pub. No.: US 2026/0288979 A1
(43) Pub. Date: Sep. 24, 2026

(54) Acceleration Device and Computing Acceleration System

(71) Applicant: IEIT SYSTEMS (BEIJING) CO., LTD, Beijing (CN)

(72) Inventors: Linge XIAO, Beijing (CN); Yanwei WANG, Beijing (CN); Rui HAO, Beijing (CN); Qianqian ZHAO, Beijing (CN)

(73) Assignee: IEIT SYSTEMS (BEIJING) CO., LTD, Beijing (CN)

(21) Appl. No.: 19/168,109

(22) PCT Filed: Nov. 28, 2024
(86) PCT No.: PCT/CN2024/135307

§ 371 Date: Sep. 23, 2025

(30) Foreign Application Priority Data
Dec. 1, 2023 (CN) 202311639194.5

(51) Int. Cl. G06F 21/60; G06F 9/445; G06F 9/50; H04L 9/08

(52) U.S. Cl. CPC G06F 21/602; G06F 9/44505; G06F 9/5016; G06F 9/5027; H04L 9/0825

(57) ABSTRACT

Disclosed are an acceleration device and a computing acceleration system. The acceleration device includes: a compute express link hard core module, configured to receive a computing request sent by a host, and forward the computing request; and an accelerated computing module deployed with an asymmetric encryption algorithm, configured to access, in response to receiving the computing request, and based on the computing request, data to be computed that is generated by the host and is in address space subjected to unified addressing, perform asymmetric encryption computation on the data to be computed to obtain result data based on an asymmetric encryption and decryption algorithm, and write the result data to the address space subjected to unified addressing, to make the host accesses the result data in the address space subjected to unified addressing.

### CROSS-REFERENCE TO RELATED APPLICATION

This disclosure is a National Stage Entry under 35 U.S.C. § 371 of PCT International Application No. PCT/CN2024/135307, filed on Nov. 28, 2024, which claims priority to Chinese Patent Application No. 202311639194.5 filed to the China National Intellectual Property Administration on Dec. 1, 2023 and entitled “Acceleration Device and Computing Acceleration System”, the entire contents of each of which are incorporated herein by reference for all purposes.

### TECHNICAL FIELD

The present disclosure relates to the field of accelerated computing, and in particular, to an acceleration device and a computing acceleration system.

### BACKGROUND

With the popularization of high-speed mobile communication devices and the advancement of industrial digitalization across industries, how to reliably and efficiently establish a secure communication link has become paramount, and computations based on various encryption and decryption protocols play a particularly crucial role in establishing the secure communication link. The encryption and decryption protocols primarily use symmetric and asymmetric encryption technologies. Among these, asymmetric encryption uses different secret keys for encryption and decryption, providing relatively high security, but the cost of computation is high. Due to the high computation cost of asymmetric encryption and decryption algorithms, the algorithms are typically used for secret key agreement.

At present, the development of a hardware acceleration unit for establishing a secure communication link based on a Transport Layer Security (TLS) secret key agreement protocol has reached a relatively mature stage. Generally, the entire TLS protocol and a lower Transmission Control Protocol (TCP)/Internet Protocol (IP) protocol stack are placed in an accelerator card, and an accelerator in the accelerator card is responsible for all operation of this portion of the network protocol stack. A communication between the accelerator and a server in which a Central Processing Unit (CPU) is located is performed by using Peripheral Component Interconnect Express (PCIe). When the server sends, to the accelerator, data required for establishing the secure communication link, source data required for computing needs to be migrated into an accelerator card side memory from a memory of the host side. After the accelerator completes computing, result data also needs to be migrated to the host side memory from the accelerator card side memory, increasing data transmission delay.

Therefore, how to provide a solution to solve the above technical problems is the current problem to be solved by those skilled in the art.

### SUMMARY

The present disclosure is intended to provide an acceleration device and a computing acceleration system, which can reduce the number of times of data migration in an acceleration process, thereby reducing data transmission delays.

In order to resolve the above technical problems, the present disclosure provides an acceleration device, including:
a storage module, in response to the acceleration device being connected to a host, the host performs unified addressing on an address space of a host memory and an address space of the storage module to make the host directly accesses the storage module and the acceleration device directly accesses the host memory;
a compute express link hard core module, configured to receive a computing request sent by the host, and forward the computing request;
an accelerated computing module deployed with an asymmetric encryption algorithm is configured to access, in response to receiving the computing request, and based on the computing request, data to be computed that is generated by the host and is in the address space subjected to unified addressing, perform asymmetric encryption computation on the data to be computed to obtain result data based on an asymmetric encryption and decryption algorithm, and write the result data to the address space subjected to unified addressing, to make the host accesses the result data in the address space subjected to unified addressing.

In some exemplary embodiments of the present disclosure, the accelerated computing module includes a register configuration unit and a computing unit, the register configuration unit includes at least one parameter register, and the computing request includes configuration information of the at least one parameter register;

The compute express link hard core module, configured to receive the computing request sent by the host, analyze the configuration information in the computing request, and write the configuration information to the corresponding parameter register; and
the computing unit, configured to determine a source address and a destination address based on the configuration information in each parameter register, access, based on the source address, the data to be computed that is generated by the host and is in the address space subjected to unified addressing, perform asymmetric encryption computation on the data to be computed to obtain the result data based on the asymmetric encryption and decryption algorithm, and write the result data to the address space subjected to unified addressing based on the destination address, to make the host accesses the result data in the address space subjected to unified addressing.

In some exemplary embodiments of the present disclosure, the parameter register includes an initiation register and an enable register; the computing unit includes at least one computing sub-unit; each computing sub-unit incorporates the asymmetric encryption and decryption algorithm; the parameter register further includes a destination address register and a source address register, which correspond to each computing sub-unit on a one-to-one basis; the configuration information includes initiation information and enable information.

The compute express link hard core module, configured to, in response to receiving the computing request, analyze the enable information and the initiation information in the computing request, write the enable information to the enable register, and write the initiation information to the initiation register, wherein the enable information includes a configuration value of each configuration bit in the enable register, and the initiation information includes a configuration value of the initiation register.

Each computing sub-unit is configured to, in response to detecting that the configuration value of the corresponding configuration bit in the enable register is a first enable preset value and the configuration bit of the initiation register is an initiation preset value, based on the source address stored in the source address register that corresponds one-to-one with each computing sub-unit, access the address space subjected to unified addressing, acquire the data to be computed that is sent by the host, perform asymmetric encryption computation on the data to be computed to obtain the result data based on the asymmetric encryption and decryption algorithm, and write, to the address space subjected to unified addressing, the result data based on the destination address stored in the destination address register that corresponds one-to-one with each computing sub-unit, to make the host accesses the result data in the address space subjected to unified addressing.

In some exemplary embodiments of the present disclosure, each computing sub-unit, further configured to remain inactive in response to detecting that the configuration value of the corresponding configuration bit in the enable register is a second enable preset value and the configuration bit of the initiation register is the initiation preset value.

In some exemplary embodiments of the present disclosure, each computing sub-unit, further configured to remain inactive in response to detecting that the configuration value of the corresponding configuration bit in the enable register is the first enable preset value and the configuration bit of the initiation register is a close preset value.

In some exemplary embodiments of the present disclosure, the accelerated computing module further includes an arbitration unit, and the arbitration unit includes a request and response arbitration sub-unit.

The computing unit, configured to determine the source address and the destination address based on the configuration information in each parameter register, initiate a read data request to the arbitration unit based on the source address such that the data to be computed that is generated by the host and is in the address space subjected to unified addressing is accessed based on the source address, perform asymmetric encryption computation on the data to be computed to obtain the result data based on the asymmetric encryption and decryption algorithm, and initiate a write data request to the arbitration unit based on the destination address such that the result data is written, based on the destination address, to the address space subjected to unified addressing.

The request and response arbitration sub-unit is configured to perform polling based on a polling cycle, and respond to the read data request or write data request initiated by the computing unit.

In some exemplary embodiments of the present disclosure, the arbitration unit further includes a management sub-unit.

The management sub-unit is configured to generate alarm information in response to the computing unit and the register configuration unit being in an abnormal state.

The compute express link hard core module, further configured to report the alarm information to the host.

In some exemplary embodiments of the present disclosure, the parameter register further includes a completion state register.

Each computing sub-unit, further configured to, in response to asymmetric encryption computation being perform on the data to be computed to obtain the result data based on the asymmetric encryption and decryption algorithm, adjust a configuration value of a corresponding configuration bit in the completion state register to a completion preset value.

The compute express link hard core module, further configured to send, to the host, an interrupt prompt signal generated by each configuration value of the completion state register such that the host, after receiving the interrupt prompt signal, accesses the result data in the address space subjected to unified addressing.

In some exemplary embodiments of the present disclosure, the computing request is a computing request that is generated based on each configuration value of the completion state register.

In some exemplary embodiments of the present disclosure, the host is further configured to determine a target computing sub-unit based on each configuration value of the completion state register, generate the computing request based on the target computing sub-unit, and generate the data to be computed to a source address corresponding to the target computing sub-unit.

In some exemplary embodiments of the present disclosure, the parameter register further includes a first cleaning register.

The compute express link hard core module, further configured to receive the first cleaning request sent by the host, and configure the configuration value of the first cleaning register based on the first cleaning request.

The process of generate the interrupt prompt signal based on each configuration value of the completion state register includes:
when the configuration value of the first cleaning register is a report-allowing configuration value and the completion preset value exists among configuration values of the completion state register, generate the interrupt prompt signal.

In some exemplary embodiments of the present disclosure, the first cleaning register, further configured to, after the configuration value is adjusted to a report-prohibiting configuration value, adjust the configuration value to the report-allowing configuration value after a preset interval of time period.

In some exemplary embodiments of the present disclosure, the parameter register further includes a second cleaning register.

The compute express link hard core module, further configured to receive the first cleaning request sent by the host, and configure the configuration value of the first cleaning register based on the first cleaning request.

The completion state register, further configured to adjust the configuration value of each configuration bit based on the configuration value of the first cleaning register.

In some exemplary embodiments of the present disclosure, the address space subjected to unified addressing includes a plurality of sub-address spaces, and an operation mode of each of the sub-address spaces is a host bias mode or a device bias mode.

The accelerated computing module is further configured to generate a notification information before the sub-address space in the host bias mode is accessed, receive confirmation indication information returned by the host based on the notification information, and access the sub-address space in the host bias mode.

In some exemplary embodiments of the present disclosure, the sub-address space storing the data to be computed is configured to be in the device bias mode, and the sub-address space storing the result data is configured to be in the host bias mode.

In some exemplary embodiments of the present disclosure, the asymmetric encryption and decryption algorithm is an elliptic curve algorithm.

In some exemplary embodiments of the present disclosure, the compute express link hard core module includes:
a transceiver, configured to receive the computing request and a memory access request sent by the host, and forward the computing request and the memory access request; the function control unit, configured to receive the computing request forwarded by the transceiver, and configure the accelerated computing module based on the computing request;
a consistency engine unit; configured to receive the memory access request forwarded by the transceiver and/or a memory access request sent by the accelerated computing module, and access the storage module based on the memory access request.

In some exemplary embodiments of the present disclosure, the consistency engine unit further includes:
a host cache, configured to cache host memory data corresponding to the memory access request;
a device cache, configured to cache device memory data corresponding to the memory access request;
a request processing sub-unit, configured to receive the memory access request sent by a sending end, determine whether the host cache or the device cache has data corresponding to the memory access request, and in response to the host cache or the device cache has data corresponding to the memory access request, return the data back to the sending end, wherein the sending end is the host or the accelerated computing module.

In some exemplary embodiments of the present disclosure, the compute express link hard core module further includes:
an interrupt interface, configured to detect an interrupt control signal that is generated in response to the accelerated computing module meets a processing condition;
the function control unit, further configured to convert the interrupt control signal into the interrupt prompt signal.
the transceiver, further configured to report the interrupt prompt signal to the host to make the host accesses the result data in the address space subjected to unified addressing.

In order to resolve the above technical problems, the present disclosure further provides a computing acceleration system, including a host and any one of the acceleration devices described above.

The present disclosure provides the acceleration device, including the storage module, the accelerated computing module, and the compute express link hard core module supporting an express link protocol. In response to the acceleration device being connected to the host, the host performs unified addressing on the address space of the host memory and the address space of the storage module to make the host directly accesses the storage module and the acceleration device directly accesses the host memory. The acceleration device may directly access the address space subjected to unified addressing to acquire the data to be computed that is generated by the host, perform asymmetric encryption computation on the data to be computed to obtain the result data based on the asymmetric encryption and decryption algorithm, and write the result data to the address space subjected to unified addressing to make the host accesses and acquires the result data after asymmetric encryption computation. Therefore, the number of times of data migration in an acceleration process is reduced, thereby reducing data transmission delays. The present disclosure further provides the computing acceleration system, which has the beneficial effects same as the above acceleration device.

### BRIEF DESCRIPTION OF THE DRAWINGS

In order to describe the embodiments of the present disclosure more clearly, the drawings required to be used in the embodiments will be simply introduced below. It is apparent that the drawings in the following descriptions are only some embodiments of the present disclosure. Those of ordinary skill in the art may further obtain other drawings according to these drawings without creative work.

FIG. 1 is a schematic structural diagram of an acceleration device according to the present disclosure.

FIG. 2 is a schematic structural diagram of an accelerated computing module according to the present disclosure.

FIG. 3 is a schematic structural diagram of a CXL hard core module according to the present disclosure.

### DETAILED DESCRIPTION OF THE EMBODIMENTS

The core of the present disclosure is to provide an acceleration device and a computing acceleration system, which can reduce the number of times of data migration in an acceleration process, thereby reducing data transmission delays.

In order to make objectives, solutions, and advantages of embodiments of the present disclosure clearer, the solutions in the embodiments of the present disclosure will be clearly and completely described below in combination with the drawings in the embodiments of the present disclosure. It is apparent that the described embodiments are part of the embodiments of the present disclosure, not all the embodiments. All other embodiments obtained by those of ordinary skill in the art on the basis of the embodiments in the present disclosure without creative work all fall within the scope of protection of the present disclosure.

In the present disclosure, modules and units are device components that are constituted by at least one processor or circuit or component or a combination thereof and have functions.

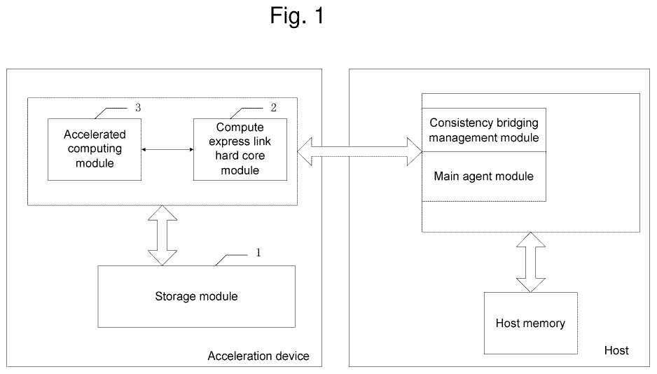

In a first aspect, referring to FIG. 1, FIG. 1 is a schematic structural diagram of an acceleration device according to the present disclosure. A host side in FIG. 1 includes a consistency bridging management module, a main agent module, and a host memory. The acceleration device includes:

a storage module 1, in response to the acceleration device being connected to a host, the host performs unified addressing on an address space of a host memory and an address space of the storage module 1 to make the host directly accesses the storage module 1 and the acceleration device directly accesses the host memory.

A compute express link hard core module 2 is configured to receive a computing request sent by the host, and forward the computing request.

An accelerated computing module 3 deployed with an asymmetric encryption algorithm is configured to access, in response to receiving the computing request, and based on the computing request, data to be computed that is generated by the host and is in the address space subjected to unified addressing, perform asymmetric encryption computation on the data to be computed to obtain result data based on an asymmetric encryption and decryption algorithm, and write the result data to the address space subjected to unified addressing, to make the host accesses the result data in the address space subjected to unified addressing.

In this embodiment, the storage module 1 may be a Host-managed Device Memory (HDM) in the acceleration device. It may be understood that, when the acceleration device is connected to the host, during initialization of the host side, the storage module 1 of the acceleration device may be recognized. In this case, after unified address space addressing is performed on the address space of the storage module 1 of the acceleration device and the address space of the host memory based on a Compute Express Link (CXL) protocol, the host may directly access a device side memory of the acceleration device, and the acceleration device may also directly access the host memory. Exemplarily, assuming that the address space of the host memory is ADDR1-ADDR2 (address), the address space of the storage module 1 is ADDR3-ADDR4, before unified addressing is performed on the address spaces, the address space that a CPU of the host may access is ADDR1-ADDR2, the address space that the acceleration device may access is ADDR3-ADDR4, and after unified address space addressing is performed on the address space of the host memory and the address space of the storage module 1, the address space that the CPU of the host and the acceleration device may access is ADDR1-ADDR4. Since the device memory and the host memory are subjected to unified addressing, the device and the host can both directly access the device side memory, such that a device side resource is fully used, and the occupation of the host side memory is reduced, thereby improving resource utilization.

The CXL hard core module 2 is connected to the host via a PCIe bus, receives, via a CXL. io protocol link, the computing request sent by the host, forwards the computing request to the accelerated computing module 3, receives a memory access request via a CXL. cache protocol link and a CXL. mem protocol link, and accesses the device memory. It may be understood that, the memory access request may be sent by the host, or may also be sent by other CXL devices connected to the acceleration device, or is sent by the accelerated computing module 3 in the acceleration device. It may be understood that, the CXL.io protocol is essentially an enhanced PCIe 5.0 protocol, and is designed for initialization, linking, device discovery and enumeration, and register access. The protocol provides a loading/storage interface for Input/Output (I/O) devices. The CXL.cache protocol defines interaction between the host and the acceleration device, allowing the connected acceleration device to efficiently cache the host memory with an extremely-low delay. The CXL.mem protocol provides loading and storage commands, such that the CPU of the host may access a memory connected to the acceleration device. In this case, the CPU of the host serves as a master device, and the acceleration device serves as a slave device, and may support volatile and non-volatile memory architectures.

The accelerated computing module 3 is deployed with the asymmetric encryption and decryption algorithm. The asymmetric encryption and decryption algorithm may be an elliptic curve algorithm. It may be understood that, with the same secret key security, a secret key agreement protocol for the asymmetric encryption algorithm based on the elliptic curve algorithm requires less computing amount. With the same computing amount, the security of the secret key agreement protocol for the asymmetric encryption algorithm based on the elliptic curve algorithm is relatively higher. Based on this, the accelerated computing module 3 in this embodiment is deployed with the elliptic curve algorithm. The accelerated computing module 3, in response to the computing request, accesses the data to be computed that is generated by the host side and in the address space subjected to unified addressing, that is, the accelerated computing module 3, in response to the computing request, directly accesses the host memory to acquire the data to be computed that is generated by the host side, performs, based on the elliptic curve algorithm, asymmetric encryption computation on the data to be computed to obtain the result data, and writes same to the address space subjected to unified addressing.

In this embodiment, the accelerated computing module 3 only implements the elliptic curve algorithm in the TLS protocol that has poor computing efficiency of the host CPU. The remaining control logic in the TLS protocol and computing logic excelled by the CPU are all processed by the CPU. Meanwhile, since the accelerated computing module 3 only implements the acceleration of the elliptic curve algorithm, the size of data blocks transmitted is greatly decreased, fully using the characteristics of the CXL protocol of lower delays under small data blocks relative to the PCIe protocol. Since the acceleration device in this embodiment is not deployed with a complete TLS protocol, resource occupation in the acceleration device is reduced.

It may be seen that, in this embodiment, the storage module 1, the accelerated computing module 3, and the CXL hard core module 2 supporting an express link protocol are included. When the acceleration device is connected to the host, the host performs unified addressing on the address space of the host memory and the address space of the storage module 1 to make the host directly accesses the storage module 1 and the acceleration device directly accesses the host memory. The acceleration device may directly access the address space subjected to unified addressing to acquire the data to be computed that is generated by the host, perform asymmetric encryption computation on the data to be computed to obtain the result data based on the asymmetric encryption and decryption algorithm, and write the result data to the address space subjected to unified addressing to make the host accesses and acquires the result data after asymmetric encryption computation. Therefore, the number of times of data migration in an acceleration process is reduced, thereby reducing data transmission delays.

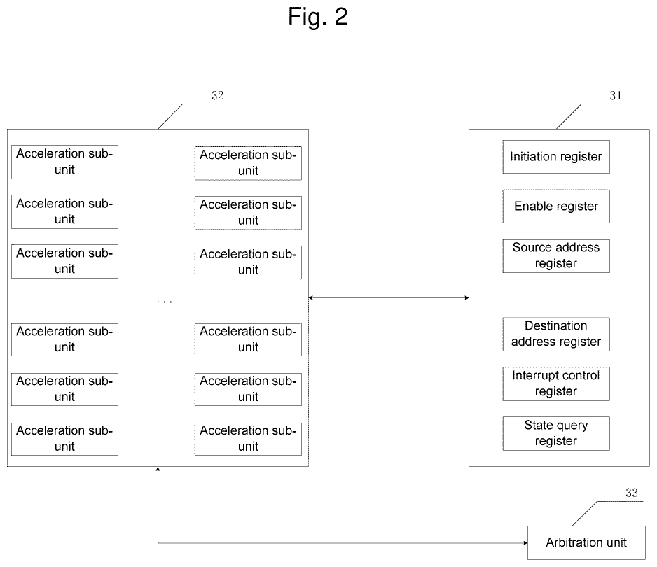

On the basis of the above embodiments:
in some exemplary embodiments of the present disclosure, referring to FIG. 2, the accelerated computing module includes a register configuration unit 31 and a computing unit 32, the register configuration unit 31 includes at least one parameter register, and the computing request includes configuration information of the at least one parameter register.

The CXL hard core module 2 is configured to receive the computing request sent by the host, analyze the configuration information in the computing request, and write the configuration information to the corresponding parameter register.

The computing unit 32 is configured to determine a source address and a destination address based on the configuration information in each parameter register, access, based on the source address, the data to be computed that is generated by the host and is in the address space subjected to unified addressing, perform asymmetric encryption computation on the data to be computed to obtain the result data based on the asymmetric encryption and decryption algorithm, and write, based on the destination address, the result data to the address space subjected to unified addressing, to make the host accesses the result data in the address space subjected to unified addressing.

In this embodiment, the accelerated computing module 3 includes the computing unit 32 and the register configuration unit 31. The register configuration unit 31 includes at least one parameter register. The CXL hard core module 2 receives the computing request via the CXL.io, then analyzes the computing request, obtains the configuration information of the at least one parameter register included in the computing request through analysis, and writes the configuration information to the corresponding parameter register. It may be understood that, the computing unit 32 is connected to each parameter register, and a computing task required to be completed by the computing unit 32 is determined based on a configuration value of each parameter register.

In some exemplary embodiments of the present disclosure, the parameter register includes an initiation register and an enable register; the computing unit 32 includes at least one computing sub-unit; each computing sub-unit incorporates the asymmetric encryption and decryption algorithm; the parameter register further includes a destination address register and a source address register, which correspond to each computing sub-unit on a one-to-one basis; the configuration information includes initiation information and enable information.

The CXL hard core module 2 is configured to receive the computing request, analyze the enable information and the initiation information in the computing request, write the enable information to the enable register, and write the initiation information to the initiation register, wherein the enable information includes a configuration value of each configuration bit in the enable register, and the initiation information includes a configuration value of the initiation register.

Each computing sub-unit is configured to, in response to detecting that the configuration value of the corresponding configuration bit in the enable register is a first enable preset value and the configuration bit of the initiation register is an initiation preset value, based on the source address stored in the source address register that corresponds one-to-one with each computing sub-unit, access the address space subjected to unified addressing, acquire the data to be computed that is sent by the host, perform asymmetric encryption computation on the data to be computed to obtain the result data based on the asymmetric encryption and decryption algorithm, and write, to the address space subjected to unified addressing, the result data based on the destination address stored in the destination address register that corresponds one-to-one with each computing sub-unit, to make the host accesses the result data in the address space subjected to unified addressing.

In some exemplary embodiments of the present disclosure, each computing sub-unit is further configured to remain inactive in response to detecting that the configuration value of the corresponding configuration bit in the enable register is the first enable preset value and the configuration bit of the initiation register is a close preset value.

In some exemplary embodiments of the present disclosure, each computing sub-unit is further configured to remain inactive in response to detecting that the configuration value of the corresponding configuration bit in the enable register is a second enable preset value and the configuration bit of the initiation register is the initiation preset value.

In this embodiment, the register configuration unit 31 includes, but is not limited to, the initiation register, the enable register, the source address register, and the destination address register. The enable register includes a plurality of configuration bits, and the plurality of configuration bits are correspondingly connected to the plurality of computing sub-units on a one-to-one basis. Each computing sub-unit is correspondingly connected to one source address register and one source address register. A bit width of each parameter register may be adjusted based on actual engineering requirements. When the bit width of the parameter register does not meet a requirement of the computing sub-unit in the computing unit 32, a plurality of same type of registers may be arranged, for example, a plurality of enable registers.

Exemplarily, assuming that the computing unit 32 includes sixty-four computing sub-units, two 32-bit enable registers may be included, which respectively are params_enable_low and params_enable_high, where the params_enable_low is configured to control whether No. 0-31 computing sub-units are enabled, and the params_enable_high is configured to control whether No. 32-63 computing sub-units are enabled. The source address register params_csr_xx_0 and the destination address register params_csr_xx_1 are correspondingly arranged with the computing sub-units on a one-to-one basis, and xx is used to indicate the number of the corresponding computing sub-unit. The initiation register params_ecc_start is configured to control the enabled computing sub-units to initiate to perform asymmetric encryption computation. When the host is used to rewrite the params_csr_02_0 register to 0x60000 via the CXL. io protocol, it indicates that the No. 2 computing sub-unit acquires, from the address 0x60000, source data required for computing, that is, acquires the data to be computed. When the params_csr_02_1 register is rewritten to 0x70000, it indicates that the result data obtained by the computing sub-unit is written to the 0x70000 address space. The params_enable_low, the params_enable_high and the params_ecc_start operate cooperatively to decide which computing sub-units are initiated for computation. For example, assuming that in the params_enable_low and params_enable_high registers with widths being 32 bits, all bits are 1. It may be understood that, the bit is the configuration bit in this embodiment, 1 is the first enable preset value, and 0 is the second enable preset value. In this case, in response to the params_ecc_start being written to 1, all the 64 computing sub-units are initiated for computation; in response to the params_enable_low being set to ‘b0000_0000_0000_0000_0000_0000_0000_1111 (i.e., No. 0-3 computing sub-units), the params_enable_high is set to ‘b0000_0000_0000_0000_0000_0000_1111_0000 (i.e., No. 36-39computing sub-units), and then the params_ecc_start is written to 1. Herein, 1 may be set to the initiation preset value, 0 is set to the close preset value, and No. 0-3 and No. 36-39 computing sub-units are initiated for computation by writing the params_ecc_start to 1.

In some exemplary embodiments of the present disclosure, the accelerated computing module 3 further includes an arbitration unit 33, and the arbitration unit 33 includes a request and response arbitration sub-unit.

The computing unit 32 is configured to determine the source address and the destination address based on the configuration information in each parameter register, initiate a read data request to the arbitration unit 33 based on the source address such that the data to be computed that is generated by the host and is in the address space subjected to unified addressing is accessed based on the source address, perform asymmetric encryption computation on the data to be computed to obtain the result data based on the asymmetric encryption and decryption algorithm, and then initiate a write data request to the arbitration unit 33 based on the destination address such that the result data is written, based on the destination address, to the address space subjected to unified addressing.

The request and response arbitration sub-unit is configured to perform polling based on a polling cycle, and respond to the read data request or write data request initiated by the computing unit 32.

It may be understood that, the initiated computing sub-unit acquires the source address based on the values of the respective params_csr_xx_0 source address registers, sends the read data request to the request and response arbitration sub-unit, after computation is completed, acquires the destination address based on the values of the respective params_csr_xx_1 registers, sends the write data request to the request and response arbitration sub-unit, and writes the computing result to the destination address.

In some exemplary embodiments of the present disclosure, the arbitration unit 33 further includes a management sub-unit.

The management sub-unit is configured to generate alarm information in response to the computing unit 32 and the register configuration unit 31 being in an abnormal state.

The CXL hard core module is further configured to report the alarm information to the host.

Considering the low efficiency of arbitration polling responses, the management sub-unit is also arranged here. The alarm information is generated immediately and reported to the host in response to the computing unit 32 and the register configuration unit 31 being in the abnormal state, such that the abnormality is processed in a timely manner.

In some exemplary embodiments of the present disclosure, the parameter register further includes a completion state register.

Each computing sub-unit is further configured to, in response to asymmetric encryption computation being perform on the data to be computed to obtain the result data based on the asymmetric encryption and decryption algorithm, adjust a configuration value of a corresponding configuration bit in the completion state register to a completion preset value.

The CXL hard core module 2 is further configured to send, to the host, an interrupt prompt signal generated by each configuration value of the completion state register such that the host, after receiving the interrupt prompt signal, accesses the result data in the address space subjected to unified addressing.

In some exemplary embodiments of the present disclosure, the computing request is a computing request that is generated based on each configuration value of the completion state register.

In some exemplary embodiments of the present disclosure, the host is further configured to determine a target computing sub-unit based on each configuration value of the completion state register, generate the computing request based on the target computing sub-unit, and generate the data to be computed to a source address corresponding to the target computing sub-unit.

In some exemplary embodiments of the present disclosure, the parameter register further includes a first cleaning register.

The CXL hard core module 2 is further configured to receive the first cleaning request sent by the host, and configure the configuration value of the first cleaning register based on the first cleaning request.

The process of generate the interrupt prompt signal based on each configuration value of the completion state register includes:

When the configuration value of the first cleaning register is a report-allowing configuration value and the completion preset value exists among h configuration values of the completion state register, the interrupt prompt signal is generated.

In some exemplary embodiments of the present disclosure, the first cleaning register is further configured to, after the configuration value is adjusted to a report-prohibiting configuration value, adjust the configuration value to the report-allowing configuration value after a preset interval of time period.

In some exemplary embodiments of the present disclosure, the parameter register further includes a second cleaning register.

The CXL hard core module 2 is further configured to receive the first cleaning request sent by the host, and configure the configuration value of the first cleaning register based on the first cleaning request.

The completion state register is further configured to adjust the configuration value of each configuration bit based on the configuration value of the first cleaning register.

It may be understood that, the number of the completion state registers may also be determined based on its bit width and the number of the computing sub-units in the computing unit 32. Assuming that the computing unit 32 includes sixty-four computing sub-units, each has a 1-bit completion signal. The sixty-four 1-bit completion signals are connected to the params_done_low and params_done_high 32-bit registers, that is, the completion state registers. The former is configured to store the completion signals of No. 0-31 computing sub-units, and the latter is configured to store the completion signals of No. 32-63 computing sub-units. The configuration value of the params_irq_clear in the first cleaning register is set by the host. Whether the host is allowed to report the interrupt prompt signal may be determined through the configuration value of the first cleaning register, the report-allowing configuration value may be allowed to be 0, and the report-prohibiting configuration value is 1. When the 64 bits of the params_done_low and params_done_high registers are not all zeros and the params_irq_clear is not 1, the interrupt control signal IRQ is outputted. After detecting the effective interrupt control signal, the CXL hard core module 2 converts the interrupt control signal into the interrupt prompt signal and reports same to the host.

Herein, the interrupt control signal may be effective on a high level. The parameter register further includes second cleaning registers params_done_low_clear and params_done_high_clear, which are configured to perform zero clearing on the completion signals stored by the bits corresponding to the params_done_low and params_done_high 32-bit registers. For example, assuming that the params_done_low and params_done_high registers both are currently 0xffffffff, that is, all the sixty-four computing sub-units complete computing. In this case, the host sets the params_done_low_clear and params_done_high_clear to 0xffffffff and 0x0, respectively, indicating that the completion signal of the No. 0 computing sub-unit is cleared and the completion signal of the No. 63 computing sub-unit is not cleared.

Actually, it indicates that the host has acquired a result of the No. 0 computing sub-unit, and after clearing, the No. 0-32 computing sub-units may perform new computing tasks.

Furthermore, after using the params_done_low_clear and params_done_high_clear registers to clear part or all of the completion signals each time, the host also needs to set the params_irq_clear to 1. The register is automatically reset to 0 after remaining set to 1 for a clock cycle, of which purpose is to notify the computing device that upper-layer software has completed processing part or all of the result data, and may continuously trigger further interrupt notifications upward based on the state of the interrupt control signal IRQ. It may be understood that, the host may not process all the completion signals at once, which may process a part of the completion signals first. That is, the bits set to 1 in the params_done_low and params_done_high registers are partially cleared.

Since there are still bits set to 1 exist, and the IRQ is still 1, after setting the params_irq_clear to 1, the host can continuously receive the interrupt signals.

In some exemplary embodiments of the present disclosure, the address space subjected to unified addressing includes a plurality of sub-address spaces, and an operation mode of each of the sub-address spaces is a host bias mode or a device bias mode.

The accelerated computing module 3 is further configured to generate a notification information before the sub-address space in the host bias mode is accessed, receive confirmation indication information returned by the host based on the notification information, and then access the sub-address space in the host bias mode.

In some exemplary embodiments of the present disclosure, the sub-address space storing the data to be computed is configured to be in the device bias mode, and the sub-address space storing the result data is configured to be in the host bias mode.

The most significant difference between the CXL protocol and the PCIe protocol lies in that, unified address space addressing is achieved, the device and the host both can directly access the host memory and the device memory, and the device and the host both have cache consistency. In order to minimize the impact of the cache consistency on delays of the host or device access to HDM, the operation mode of the HDM is further divided into two types, which respectively are a host bias mode and a device bias mode. In the host bias mode, the delay of the host access to the HDM is optimized, such that the host bias mode is generally used in a stage in which the host issues the task data to the device before initiating a task and the host reads the data after the device completes the task.

In the mode, when the device wants to access the HDM, the device needs to first notify the host-side consistency bridging management, and may access the HDM after obtaining permission. In the device bias mode, the delay of the device access to the HDM is optimized, such that the device bias mode is generally used after the device starts performing the acceleration task and before the host reads the result data.

In the mode, the device may directly access the without notifying the consistency bridging management module of the host side, and ensure that the host does not own a cache of an HDM memory region in the device bias mode state. In this case, the host may still access the HDM, but the access performance may be reduced relative to the host bias mode.

Which sub-address spaces belong to the host bias mode and which sub-address spaces belong to the device bias mode in the HDM may be controlled and managed through a main agent software module of the host side. In a consistency engine, through a Bias Table, the state of Bias of each page (i.e., 4 kB) in the HDM is tracked, and it means that the Bias mode of the memory in the HDM may be set and managed based on a particle size of 4 kB.

Assuming that the data to be computed of all the computing sub-units are stored in the ADDR1-ADDR2 address spaces (with a size being an integer multiple of 4 kB), and the result data of all the computing sub-units are stored in the ADDR3-ADDR4 address spaces (with a size being an integer multiple of 4 kB). Since an operation mode of an elliptic curve accelerated multiplication is simple enough, the data is only read from the ADDR1-ADDR2 address spaces, and is written back to the address spaces ADDR3-ADDR4 after computing is completed. For the address spaces ADDR1-ADDR2, the host serves as a write part of the data and does not need to use the data of the address spaces, such that the cache of the data in the address spaces does not need to be stored. This part of the address spaces is set to the device bias mode, such that performance losses may be minimized. Since the host no longer needs to acquire this part of data, the absence of the cache does not cause increased delays. Meanwhile, the device may directly access the address space without host permission and cache partial data to the consistency engine unit to accelerate access.

For the address spaces ADDR3-ADDR4, the computing sub-unit serves as a write part of the result data, and also no longer needs to acquire the result data. By setting the address spaces ADDR3-ADDR4 to the host bias mode, when using the result data to update the address spaces, the device side needs to notify the consistency bridging management module of the host side first, such that the host side can learn that the data in the address spaces needs to be updated, and the cache of the CPU of the host side is updated to the latest data.

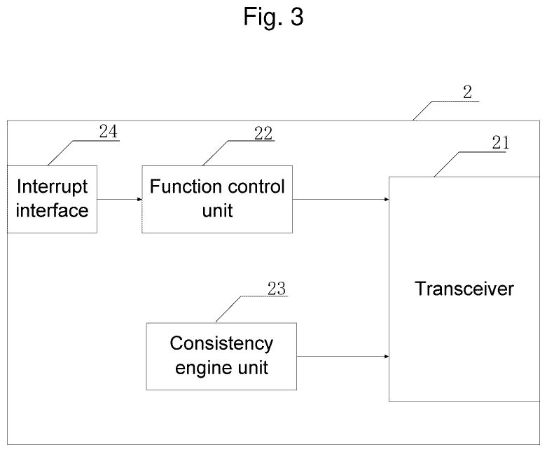

In some exemplary embodiments of the present disclosure, referring to FIG. 3, the CXL hard core module 2 includes:
a transceiver 21 is configured to receive the computing request and a memory access request sent by the host, and forward the computing request and the memory access request.

A function control unit 22 is configured to receive the computing request forwarded by the transceiver 21, and configure the accelerated computing module 3 based on the computing request.

A consistency engine unit 23 is configured to receive the memory access request forwarded by the transceiver 21 and/or a memory access request sent by the accelerated computing module 3, and access the storage module 1 based on the memory access request.

In some exemplary embodiments of the present disclosure, the consistency engine unit 23 includes:
a host cache is configured to cache host memory data corresponding to the memory access request.

A device cache is configured to cache device memory data corresponding to the memory access request.

The request processing sub-unit is configured to, in response to receiving the memory access request sent by a sending end, determine whether the host cache or the device cache has data corresponding to the memory access request, and in response to the host cache or the device cache has data corresponding to the memory access request, return the data back to the sending end, wherein the sending end is the host or the accelerated computing module 3.

In this embodiment, the host cache and the device cache in the consistency engine unit 23 are respectively configured to store the data read from the host memory and the data read from the device memory, and cache data in a next preset address section in the memory access request in advance, such that after the memory access request is received subsequently, whether a hit occurs is determined from its own cache; in response to the cache being hit, a sending end is directly returned, thereby improving data transmission efficiency; and in response to the cache being not hit, data is requested again from the host memory or the device memory.

In some exemplary embodiments of the present disclosure, the CXL hard core module 2 further includes;
an interrupt interface 24 is configured to detect an interrupt control signal that is generated when the accelerated computing module 3 meets a processing condition.

The function control unit 22 is further configured to convert the interrupt control signal into the interrupt prompt signal.

The transceiver 21 is further configured to report the interrupt prompt signal to the host to make the host accesses the result data in the address space subjected to unified addressing.

To sum up, in the present disclosure, for the computational bottleneck faced by the CPU in asymmetric encryption and decryption operations in the TLS protocol, in the present disclosure, by compiling an elliptical curve multiplication unit array module and supporting parameter registers, arbiters and other peripheral facilities, in combination with an IRQ interface, memory interface, and CSR interface provided by a CXL hard core, a heterogeneous computing system that supports the device and the host to directly access the unified addressed memory space or perform elliptical curve multiplication acceleration at a low delay is implemented for the first time, and the number of times of data migration is reduced. Furthermore, by rationally designing the register configuration unit 31, a hardware foundation is realized for initializing and using the results of any number of the elliptical curve multiplication units. By setting the operation modes of different address spaces for different stages of operations of an elliptical curve accelerator, access delays are optimized while ensuring data consistency.

In a second aspect, the present disclosure further provides a computing acceleration system, including a host and any one of the acceleration devices described above.

The acceleration device includes:
a storage module, in response to the acceleration device being connected to a host, the host performs unified addressing on an address space of a host memory and an address space of the storage module to make the host directly accesses the storage module and the acceleration device directly accesses the host memory.

The CXL hard core module is configured to receive a computing request sent by the host, and forward the computing request.

The accelerated computing module deployed with an asymmetric encryption algorithm is configured to access, in response to receiving the computing request, and based on the computing request, data to be computed that is generated by the host and is in the address space subjected to unified addressing, perform asymmetric encryption computation on the data to be computed to obtain result data based on an asymmetric encryption and decryption algorithm, and write the result data to the address space subjected to unified addressing, to make the host accesses the result data in the address space subjected to unified addressing.

In some exemplary embodiments of the present disclosure, the accelerated computing module includes a register configuration unit and a computing unit, the register configuration unit includes at least one parameter register, and the computing request includes configuration information of the at least one parameter register.

The CXL hard core module is configured to receive the computing request sent by the host, analyze the configuration information in the computing request, and write the configuration information to the corresponding parameter register.

The computing unit is configured to determine a source address and a destination address based on the configuration information in each parameter register, access, based on the source address, the data to be computed that is generated by the host and is in the address space subjected to unified addressing, perform asymmetric encryption computation on the data to be computed to obtain the result data based on the asymmetric encryption and decryption algorithm, and write, based on the destination address, the result data to the address space subjected to unified addressing, to make the host accesses the result data in the address space subjected to unified addressing.

In some exemplary embodiments of the present disclosure, the parameter register includes an initiation register and an enable register; the computing unit includes at least one computing sub-unit; each computing sub-unit incorporates the asymmetric encryption and decryption algorithm; the parameter register further includes a destination address register and a source address register, which correspond to each computing sub-unit on a one-to-one basis; the configuration information includes initiation information and enable information.

The CXL hard core module is configured to, in response to receiving the computing request, analyze the enable information and the initiation information in the computing request, write the enable information to the enable register, and write the initiation information to the initiation register, wherein the enable information includes a configuration value of each configuration bit in the enable register, and the initiation information includes a configuration value of the initiation register.

Each computing sub-unit is configured to, in response to detecting that the configuration value of the corresponding configuration bit in the enable register is a first enable preset value and the configuration bit of the initiation register is an initiation preset value, based on the source address stored in the source address register that corresponds one-to-one with each computing sub-unit, access the address space subjected to unified addressing, acquire the data to be computed that is sent by the host, perform, based on the asymmetric encryption and decryption algorithm, asymmetric encryption computation on the data to be computed to obtain the result data, and write, to the address space subjected to unified addressing, the result data based on the destination address register that corresponds one-to-one with each computing sub-unit, to make the host accesses the result data in the address space subjected to unified addressing.

In some exemplary embodiments of the present disclosure, each computing sub-unit is further configured to remain inactive in response to detecting that the configuration value of the corresponding configuration bit in the enable register is a second enable preset value and the configuration bit of the initiation register is the initiation preset value.

In some exemplary embodiments of the present disclosure, each computing sub-unit is further configured to remain inactive in response to detecting that the configuration value of the corresponding configuration bit in the enable register is the first enable preset value and the configuration bit of the initiation register is a close preset value.

In some exemplary embodiments of the present disclosure, the accelerated computing module further includes an arbitration unit, and the arbitration unit includes a request and response arbitration sub-unit.

The computing unit is configured to determine the source address and the destination address according to the configuration information in each parameter register, initiate a read data request to the arbitration unit based on the source address such that the data to be computed that is generated by the host and is in the address space subjected to unified addressing is accessed based on the source address, perform asymmetric encryption computation on the data to be computed to obtain the result data based on the asymmetric encryption and decryption algorithm, and initiate a write data request to the arbitration unit based on the destination address such that the result data is written, based on the destination address, to the address space subjected to unified addressing.

The request and response arbitration sub-unit is configured to perform polling based on a polling cycle, and respond to the read data request or write data request initiated by the computing unit.

In some exemplary embodiments of the present disclosure, the arbitration unit further includes:
a management sub-unit is configured to generate alarm information in response to the computing unit and the register configuration unit being in an abnormal state.

The CXL hard core module is further configured to report the alarm information to the host.

In some exemplary embodiments of the present disclosure, the parameter register further includes a completion state register.

Each computing sub-unit is further configured to, in response to asymmetric encryption computation being perform on the data to be computed to obtain the result data based on the asymmetric encryption and decryption algorithm, adjust a configuration value of a corresponding configuration bit in the completion state register to a completion preset value.

The CXL hard core module is further configured to send, to the host, an interrupt prompt signal generated by each configuration value of the completion state register such that the host, after receiving the interrupt prompt signal, accesses the result data in the address space subjected to unified addressing.

In some exemplary embodiments of the present disclosure, the computing request is a computing request that is generated based on each configuration value of the completion state register.

In some exemplary embodiments of the present disclosure, the host is further configured to determine a target computing sub-unit based on each configuration value of the completion state register, generate the computing request based on the target computing sub-unit, and generate the data to be computed to a source address corresponding to the target computing sub-unit.

In some exemplary embodiments of the present disclosure, the parameter register further includes a first cleaning register.

The CXL hard core module is further configured to receive the first cleaning request sent by the host, and configure the configuration value of the first cleaning register based on the first cleaning request.

The process of generate the interrupt prompt signal based on each configuration value of the completion state register includes the following operation.

When the configuration value of the first cleaning register is a report-allowing configuration value and the completion preset value exists among configuration values of the completion state register, the interrupt prompt signal is generated.

In some exemplary embodiments of the present disclosure, the first cleaning register is further configured to, after the configuration value is adjusted to a report-prohibiting configuration value, adjust the configuration value to the report-allowing configuration value after a preset interval of time period.

In some exemplary embodiments of the present disclosure, the parameter register further includes a second cleaning register.

The CXL hard core module is further configured to receive the first cleaning request sent by the host, and configure the configuration value of the first cleaning register based on the first cleaning request.

The completion state register is further configured to adjust the configuration value of each configuration bit based on the configuration value of the first cleaning register.

In some exemplary embodiments of the present disclosure, the address space subjected to unified addressing includes a plurality of sub-address spaces, and an operation mode of each of the sub-address spaces is a host bias mode or a device bias mode.

The accelerated computing module is further configured to generate a notification information before the sub-address space in the host bias mode is accessed, receive confirmation indication information returned by the host based on the notification information, and access the sub-address space in the host bias mode.

In some exemplary embodiments of the present disclosure, the sub-address space storing the data to be computed is configured to be in the device bias mode, and the sub-address space storing the result data is configured to be in the host bias mode.

In some exemplary embodiments of the present disclosure, the asymmetric encryption and decryption algorithm is an elliptic curve algorithm.

In some exemplary embodiments of the present disclosure, the CXL hard core module includes a transceiver, a function control unit, and a consistency engine unit.

The transceiver is configured to receive the computing request and a memory access request sent by the host, and forward the computing request and the memory access request.

The function control unit is configured to receive the computing request forwarded by the transceiver, and configure the accelerated computing module based on the computing request.

The consistency engine unit is configured to receive the memory access request forwarded by the transceiver and/or a memory access request sent by the accelerated computing module, and access the storage module based on the memory access request.

In some exemplary embodiments of the present disclosure, the consistency engine unit further includes a host cache, a device cache, and a request processing sub-unit.

The host cache is configured to cache host memory data corresponding to the memory access request.

The device cache is configured to cache device memory data corresponding to the memory access request.

The request processing sub-unit is configured to, in response to receiving the memory access request sent by a sending end, determine whether the host cache or the device cache has data corresponding to the memory access request, and if so, return the data back to the sending end, wherein the sending end is the host or the accelerated computing module.

In some exemplary embodiments of the present disclosure, the CXL hard core module further includes an interrupt interface.

The interrupt interface is configured to detect an interrupt control signal that is generated in response to the accelerated computing module meets a processing condition.

The function control unit is further configured to convert the interrupt control signal into the interrupt prompt signal.

The transceiver is further configured to report the interrupt prompt signal to the host such that the host accesses the result data in the address space subjected to unified addressing.

It is also to be noted that relational terms such as first and second are used merely to distinguish one entity or operation from another entity or operation herein, and do not necessarily require or imply the existence of any such actual relationship or order between these entities or operations. Furthermore, terms “comprise”, “include” or any other variants are intended to encompass non-exclusive inclusion, such that a process, a method, an article or a device including a series of elements not only include those elements, but also includes other elements not listed explicitly or includes intrinsic elements for the process, the method, the article, or the device. Without any further limitation, an element defined by the phrase “comprising one” does not exclude existence of other same elements in the process, the method, the article, or the device that includes the elements.

The above description of the disclosed embodiments enables those skilled in the art to implement or use the present disclosure. It is apparent that those skilled in the art will make many modifications to these embodiments, the general principles defined in the disclosure may be achieved in the other embodiments without departing from the spirit or scope of the present disclosure. Therefore, the present disclosure will not be limited to the embodiments shown herein, but to conform to the maximum extent of principles and new features that are disclosed herein.

1. An acceleration device, comprising:
a storage module, in response to the acceleration device being connected to a host, the host performs unified addressing on an address space of a host memory and an address space of the storage module to make the host directly access the storage module and the acceleration device directly access the host memory;
a compute express link hard core module, configured to receive a computing request sent by the host, and forward the computing request; and
an accelerated computing module deployed with an asymmetric encryption algorithm, configured to access, in response to receiving the computing request, and based on the computing request, data to be computed that is generated by the host and is in the address space subjected to unified addressing, perform asymmetric encryption computation on the data to be computed to obtain result data based on an asymmetric encryption and decryption algorithm, and write the result data to the address space subjected to unified addressing, to make the host access the result data in the address space subjected to unified addressing;
wherein the address space subjected to unified addressing comprises a plurality of sub-address spaces, and an operation mode of each of the sub-address spaces is a host bias mode or a device bias mode; and
the accelerated computing module, further configured to generate a notification information before the sub-address space in the host bias mode is accessed, receive confirmation indication information returned by the host based on the notification information, and access the sub-address space in the host bias mode.

2. The acceleration device as claimed in claim 1, wherein the accelerated computing module comprises a register configuration unit and a computing unit, the register configuration unit comprises at least one parameter register, and the computing request comprises configuration information of the at least one parameter register;
the compute express link hard core module, configured to receive the computing request sent by the host, analyze the configuration information in the computing request, and write the configuration information to the corresponding parameter register; and
the computing unit, configured to determine a source address and a destination address based on the configuration information in each parameter register, access, based on the source address, the data to be computed that is generated by the host and is in the address space subjected to unified addressing, perform asymmetric encryption computation on the data to be computed to obtain the result data based on the asymmetric encryption and decryption algorithm, and write the result data to the address space subjected to unified addressing based on the destination address, to make the host accesses the result data in the address space subjected to unified addressing.

3. The acceleration device as claimed in claim 2, wherein the parameter register comprises an initiation register and an enable register; the computing unit comprises at least one computing sub-unit; each computing sub-unit incorporates the asymmetric encryption and decryption algorithm; the parameter register further comprises a destination address register and a source address register, which correspond to each computing sub-unit on a one-to-one basis; the configuration information comprises initiation information and enable information;
the compute express link hard core module, configured to, in response to receiving the computing request, analyze the enable information and the initiation information in the computing request, write the enable information to the enable register, and write the initiation information to the initiation register, wherein the enable information comprises a configuration value of each configuration bit in the enable register, and the initiation information comprises a configuration value of the initiation register; and
each computing sub-unit, configured to, in response to detecting that the configuration value of the corresponding configuration bit in the enable register is a first enable preset value and the configuration bit of the initiation register is an initiation preset value, based on the source address stored in the source address register that corresponds one-to-one with each computing sub-unit, access the address space subjected to unified addressing, acquire the data to be computed that is sent by the host, perform asymmetric encryption computation on the data to be computed to obtain the result data based on the asymmetric encryption and decryption algorithm, and write the result data to the address space subjected to unified addressing, based on the destination address stored in the destination address register that corresponds one-to-one with each computing sub-unit, to make the host accesses the result data in the address space subjected to unified addressing.

4. The acceleration device as claimed in claim 3, wherein each computing sub-unit, further configured to remain inactive in response to detecting that the configuration value of the corresponding configuration bit in the enable register is a second enable preset value and the configuration bit of the initiation register is the initiation preset value.

5. The acceleration device as claimed in claim 3, wherein each computing sub-unit, further configured to remain inactive in response to detecting that the configuration value of the corresponding configuration bit in the enable register is the first enable preset value and the configuration bit of the initiation register is a close preset value.

6. The acceleration device as claimed in claim 2, wherein the accelerated computing module further comprises an arbitration unit, and the arbitration unit comprises a request and response arbitration sub-unit;
the computing unit, configured to determine the source address and the destination address based on the configuration information in each parameter register, initiate a read data request to the arbitration unit based on the source address such that the data to be computed that is generated by the host and is in the address space subjected to unified addressing is accessed based on the source address, perform asymmetric encryption computation on the data to be computed to obtain the result data based on the asymmetric encryption and decryption algorithm, and initiate a write data request to the arbitration unit based on the destination address such that the result data is written, based on the destination address, to the address space subjected to unified addressing; and
the request and response arbitration sub-unit, configured to perform polling based on a polling cycle, and respond to the read data request or write data request initiated by the computing unit.

7. The acceleration device as claimed in claim 6, wherein the arbitration unit further comprises:
a management sub-unit, configured to generate alarm information in response to the computing unit and the register configuration unit being in an abnormal state; and
the compute express link hard core module, further configured to report the alarm information to the host.

8. The acceleration device as claimed in claim 2, wherein the parameter register further comprises a completion state register;
each computing sub-unit, further configured to, in response to asymmetric encryption computation being perform on the data to be computed to obtain the result data based on the asymmetric encryption and decryption algorithm, adjust a configuration value of a corresponding configuration bit in the completion state register to a completion preset value; and
the compute express link hard core module, further configured to send, to the host, an interrupt prompt signal generated by each configuration value of the completion state register such that the host, after receiving the interrupt prompt signal, accesses the result data in the address space subjected to unified addressing.

9. The acceleration device as claimed in claim 8, wherein the computing request is a computing request that is generated based on each configuration value of the completion state register.

10. The acceleration device as claimed in claim 9, wherein the host, further configured to determine a target computing sub-unit based on each configuration value of the completion state register, generate the computing request based on the target computing sub-unit, and generate the data to be computed to a source address corresponding to the target computing sub-unit.

11. The acceleration device as claimed in claim 8, wherein the parameter register further comprises a first cleaning register;
the compute express link hard core module, further configured to receive a first cleaning request sent by the host, and configure a configuration value of the first cleaning register based on the first cleaning request; and
the process of generate the interrupt prompt signal based on each configuration value of the completion state register comprises:
when the configuration value of the first cleaning register is a report-allowing configuration value and the completion preset value exists among configuration values of the completion state register, generate the interrupt prompt signal.

12. The acceleration device as claimed in claim 11, wherein the first cleaning register, further configured to, after the configuration value is adjusted to a report-prohibiting configuration value, adjust the configuration value to the report-allowing configuration value after a preset interval of time period.

13. The acceleration device as claimed in claim 12, wherein the parameter register further comprises a second cleaning register;
the compute express link hard core module, further configured to receive the first cleaning request sent by the host, and configure the configuration value of the first cleaning register based on the first cleaning request; and
the completion state register, further configured to adjust the configuration value of each configuration bit based on the configuration value of the first cleaning register.

14. (canceled)

15. The acceleration device as claimed in claim 1, wherein the sub-address space storing the data to be computed is configured to be in the device bias mode, and the sub-address space storing the result data is configured to be in the host bias mode.

16. The acceleration device as claimed in claim 1, wherein the asymmetric encryption and decryption algorithm is an elliptic curve algorithm.

17. The acceleration device as claimed in claim 1, wherein the compute express link hard core module comprises:
a transceiver, configured to receive the computing request and a memory access request sent by the host, and forward the computing request and the memory access request;
a function control unit, configured to receive the computing request forwarded by the transceiver, and configure the accelerated computing module based on the computing request; and
a consistency engine unit, configured to receive the memory access request forwarded by the transceiver and/or a memory access request sent by the accelerated computing module, and access the storage module based on the memory access request.

18. The acceleration device as claimed in claim 17, wherein the consistency engine unit further comprises:
a host cache, configured to cache host memory data corresponding to the memory access request;
a device cache, configured to cache device memory data corresponding to the memory access request; and
a request processing sub-unit, configured to, in response to receiving the memory access request sent by a sending end, determine whether the host cache or the device cache has data corresponding to the memory access request, and in response to the host cache or the device cache has data corresponding to the memory access request, return the data back to the sending end, wherein the sending end is the host or the accelerated computing module.

19. The acceleration device as claimed in claim 17, wherein the compute express link hard core module further comprises:
an interrupt interface, configured to detect an interrupt control signal that is generated in response to the accelerated computing module meets a processing condition;
the function control unit, further configured to convert the interrupt control signal into the interrupt prompt signal; and
the transceiver, further configured to report the interrupt prompt signal to the host to make the host access the result data in the address space subjected to unified addressing.

20. (canceled)

21. The acceleration device as claimed in claim 3, wherein in response to a bit width of the parameter register not meeting a requirement of the computing sub-unit in the computing unit, a plurality of enable registers are arranged.

22. The acceleration device as claimed in claim 13, wherein the number of completion state registers can be determined based on its bit width and the number of the computing sub-units in the computing unit.
